(19) United States
(12) Patent Application Publication
(10) Pub. No.: US 2026/0202991 A1
(43) Pub. Date: Jul. 16, 2026

(54) WORKLOAD ADAPTIVE L2P TABLE DEALLOCATION

(71) Applicant: Micron Technology, Inc., Boise, ID (US)

(72) Inventors: Peng Fei, Shanghai (CN); Meng Wei, Shanghai (CN); Guang Shen, Shanghai (CN); Donghua Zhou, Suzhou City (CN)

(21) Appl. No.: 19/018,808

(22) Filed: Jan. 13, 2025

(51) Int. Cl. G06F 3/06

(52) U.S. Cl. CPC G06F 3/0659; G06F 3/0604; G06F 3/0679

(57) ABSTRACT

This disclosure concerns a system for dynamically controlling L2P table deallocation. The system receives a request to deallocate a set of entries of a logical-to-physical (L2P) table associated with a memory device, the set of entries corresponding to a memory device region comprising a plurality of logical translation units (LTUs) and, in response to receiving the request, deallocates a front set of LTUs of the region and a tail set of the LTUs of the region leaving a non-deallocated portion of the region. The system divides the non-deallocated portion of the region into a plurality of sub-regions and computes a size associated with a write command received from a host. The system dynamically selects a number of sub-regions in the plurality of sub-regions of the non-deallocated portion to deallocate based on the size associated with the write command.

### TECHNICAL FIELD

Examples of the disclosure relate generally to memory sub-systems and, more specifically, to improving write performance in memory sub-systems through workload adaptive deallocation techniques.

### BACKGROUND

Memory sub-systems have become increasingly prevalent in data storage applications due to their superior performance compared to traditional storage technologies. As data management demands continue to evolve, memory sub-systems, such as Solid State Drives (SSDs), are adapting to meet the complex requirements of modern storage systems. The process of deallocating data plays an important role in maintaining memory sub-system efficiency and improving storage space utilization. In datacenter environments, advanced methods for managing deallocation operations alongside read and write tasks have become increasingly important.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 is a block diagram illustrating an example computing system that includes a memory sub-system, in accordance with some examples.

FIG. 2 is a block diagram of an L2P table deallocation component, in accordance with some examples.

FIG. 3 illustrates a diagram of L2P table deallocation, in accordance with some examples.

FIG. 4 illustrates configuration information for L2P sub-regions, in accordance with some examples.

FIG. 5 illustrates a diagram of one implementation of a L2P table sub-region generation, in accordance with some examples.

FIG. 6 illustrates an adaptive policy lookup table, in accordance with some examples.

FIG. 7 illustrates an adaptive background deallocation process, in accordance with some examples.

FIG. 8 illustrates a diagram of operations performed using the L2P table deallocation component, in accordance with some examples.

FIG. 9 is a block diagram of an example computer system, according to some examples.

### DETAILED DESCRIPTION

The present disclosure is directed to a system including a memory sub-system, such as a solid-state drive (SSD) and a processing device operatively coupled to the memory sub-system, configured to perform operations that implement workload adaptive deallocation techniques to improve write performance. Specifically, the disclosed processing device receives a request to deallocate entries in a logical-to-physical (L2P) table corresponding to memory device regions including multiple logical translation units (LTUs). The processing device deallocates front and tail LTU sets of the region, leaving a non-deallocated portion, which is then divided into sub-regions. Upon receiving a write command from a host, the processing device computes the command's size and dynamically selects a number of sub-regions to deallocate based on this size. This approach enables workload-adaptive deallocation, optimizing the balance between deallocation operations and write performance in memory sub-systems. The efficiency of writing and managing data increases through this adaptive deallocation implementation. Rather than using a fixed deallocation scheme, the disclosed techniques integrate dynamic, workload-aware functionality within a memory sub-system, which improves the efficiency and flexibility of the storage device and reduces write latency in various workload scenarios. This approach allows for a customizable balance between deallocation granularity and write performance within a memory sub-system.

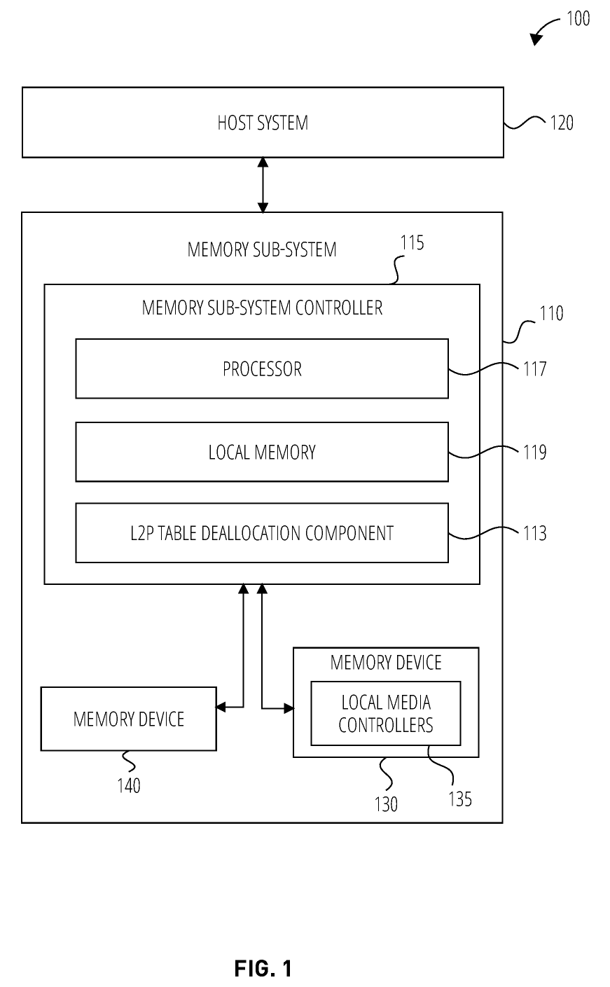

A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command, erase command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system may re-write previously written host data from a location of a memory device to a new location as part of garbage collection (GC) management operations. The data that is re-written, for example as initiated by the firmware, is hereinafter referred to as “GC data.”

Examples of system data include, but are not limited to, system tables (e.g., logical-to-physical memory address mapping table, also referred to herein as a logical-to-physical (L2P) mapping table (referred to as an L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., NAND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are a raw memory device combined with a local embedded controller for memory management within the same memory device package. The memory device can be divided into one or more zones where each zone is associated with a different set of host data or user data or application.

L2P tables are integral components in memory sub-systems, such as in SSDs. These L2P tables maintain the mapping between logical addresses used by the host system and the physical addresses where data is actually stored on the memory device, such as in memory blocks. Each entry in an L2P table can represent a Logical Translation Unit (LTU), which corresponds to a fixed-size block of data, often 4KB in size. In conventional memory sub-system designs, the L2P table is organized into regions, with each region containing a large number of LTUs. For example, a region might consist of 1024 LTUs, representing 4MB of addressable space. When a host system needs to free up space or perform operations like formatting or sanitizing, the host issues deallocate commands to the memory sub-system. These commands instruct the memory sub-system to invalidate specific ranges of logical addresses, which in turn triggers updating the corresponding L2P table entries.

The process of deallocating L2P table entries involves several time-consuming steps, including invalidating the L2P entries, identifying the associated physical blocks or block stripes, and decreasing the valid translation unit (TU) count (VTC) for each affected block or block stripe. This complexity makes deallocation a relatively slow operation compared to regular read or write operations. To address the performance impact of deallocation, some memory sub-systems implement a two-stage deallocation process. This two-stage deallocation process includes a foreground (FG) and background (BG) deallocation. The FG deallocation causes unaligned head and tail portions of a region to be deallocated leaving behind a region between the head and tail that has not yet been deallocated. That region that is left behind is ultimately deallocated overtime through the BG deallocation process. In this approach, the memory sub-system quickly deallocates the unaligned head and tail portions of a region in the FG, allowing it to acknowledge command completion to the host. The remaining aligned body of the region is then deallocated in the background while the memory sub-system continues to handle other I/O operations.

This conventional approach introduces a new set of challenges. When a host write command targets an area that is currently undergoing BG deallocation, the memory sub-system has to prioritize completing the deallocation of that area before processing the write. This scenario, referred to as priority deallocation, can adversely impact write performance, such as for random write patterns. The impact is particularly severe for small write operations. For instance, a 4KB write might trigger the priority deallocation of an entire region (e.g., 4MB), even though only a tiny fraction of that region is actually being written to. This mismatch between the granularity of host operations and the granularity of deallocation leads to significant inefficiencies and wasted resources.

Furthermore, the performance impact is not uniform across different workloads. While large sequential writes might be less affected, small random writes – which are common in many data center applications – can experience severe latency spikes. This variability in performance can be particularly problematic in environments that need consistent, predictable I/O performance. The conventional approach also struggles to adapt to changing workload patterns. A fixed deallocation strategy that might work well for one type of workload could be highly inefficient for another. This lack of adaptability becomes increasingly problematic as memory sub-systems are deployed in diverse applications with varying I/O patterns and performance requirements. In data center environments, where memory sub-systems often handle mixed workloads involving both reads and writes alongside large-scale deallocations, these inefficiencies can accumulate to create substantial performance bottlenecks. The inability to efficiently balance deallocation operations with ongoing read and write tasks can lead to inconsistent performance, increased latency, and suboptimal utilization of the memory sub-system resources.

The present disclosure addresses these inefficiencies and challenges by implementing a workload adaptive deallocation method. This disclosed approach introduces the concept of sub-regions within the L2P table regions, allowing for more flexible and efficient deallocation based on the host write command size. The disclosed techniques dynamically adjust the priority deallocate size according to the host write block size, using "size-info bits" to represent the initial write block size. This enables the disclosed techniques (through a deallocation component) to determine the optimal priority deallocate sub-region size, which reduces unnecessary deallocation efforts. The disclosed techniques optimize the background deallocation process by combining contiguous sub-regions for deallocation in one operation, which reduces the overhead associated with pre-process and post-process operations. This adaptive approach allows the disclosed techniques to balance deallocation operations with ongoing read and write tasks more effectively, particularly in data center environments where consistent high performance and low latency are needed.

By dynamically selecting the number of sub-regions to deallocate based on the size of incoming write commands, the disclosed techniques can improve write performance, such as for random write patterns. This workload-aware functionality integrated within the memory sub-system enhances the efficiency and flexibility of the storage device, reducing write latency across various workload scenarios. Ultimately, the disclosed techniques provide a customizable balance between deallocation granularity and write performance, addressing the limitations of conventional fixed deallocation strategies and adapting to diverse I/O patterns and performance requirements.

In some examples, the techniques described herein relate to a memory sub-system, such as a solid-state drive (SSD) and a processing device that receives a request to deallocate entries in a L2P table. These entries correspond to a memory device region containing multiple logical translation units (LTUs). Upon receiving this request, the processing device first deallocates the front and tail sets of LTUs in the region, leaving a non-deallocated portion in the middle. The processing device then divides this non-deallocated portion into several sub-regions. When a write command is received from a host, the processing device computes the size of this command. Based on this size, the processing device dynamically selects a number of sub-regions from the non-deallocated portion to deallocate.

In some cases, after deallocating the front and tail sets, the processing device communicates to the host that the deallocation request has been completed. This allows the host to proceed with other operations while the remaining deallocation occurs in the background. To keep track of the deallocation status, the processing device can store information for each entry in the L2P table corresponding to the non-deallocated portion. When a write command targets an LTU in the non-deallocated portion, the processing device can determine this and select the appropriate number of sub-regions to deallocate based on the write command's size. The size of the selected sub-regions is designed to be larger than the write command size but smaller than the entire non-deallocated portion. This approach balances efficiency with responsiveness.

In some examples, the sub-regions can be configured in different ways. The sub-regions may all correspond to the same number of LTUs, or they might be divided into portions with different LTU counts. The processing device can access configuration information to determine the region size and the number of LTUs each sub-region should represent. The processing device can then generate the sub-regions based on this information. If the region size is equally divisible by the sub-region LTU count, all sub-regions may be configured to have the same number of LTUs. If not, some sub-regions may have fewer LTUs than others.

When selecting sub-regions to deallocate, the processing device can compare the write command size to the sub-region size. If the command size is smaller than the sub-region size stored in the configuration information, the processing device can select at least one sub-region. If the command size larger than the sub-region size stored in the configuration information, the processing device can select multiple sub-regions to match or exceed the write command size. The number of sub-regions to deallocate can be determined by dividing the write command size by the number of LTUs per sub-region, stored in the configuration information. To improve background deallocation, the processing device identifies contiguous portions of sub-regions between already deallocated sub-regions and deallocates them completely in one process. This approach is particularly efficient when different write commands have caused non-contiguous deallocation patterns.

When deallocating an individual sub-region, the processing device can invalidate the corresponding L2P entries, identify the associated physical blocks, decreases the valid translation unit count for each block, and update a bitmap to mark the sub-region as deallocated. This entire system can be implemented within a single SSD or multiple SSD, which may use three-dimensional (3D) NAND technology. The same approach can be applied to other non-transitory machine-readable storage media and can be implemented as a method for managing deallocation in memory devices.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing system 100 that includes a memory sub-system 110, in accordance with some examples. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some examples, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random-access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, single level cells (SLCs), can store one bit per cell. Other types of memory cells, such as multi-level cells (MLCs), tri-level cells (TLCs), quad-level cells (QLCs), and penta-level cells (PLCs), can store multiple bits per cell. In some examples, each of the memory devices 130, 140 can include one or more arrays of memory cells such as SLCs, MLCs, TLCs, QLCs, or any combination of such. In some examples, a particular memory device can include an SLC portion, an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks or BSs. As used herein, a block comprising SLCs can be referred to as an SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data (e.g., performing GC operations) at the memory devices 130, 140 and other such operations. The memory sub-system controller 115 can include hardware such as one or more integrated circuits and/or discrete components, a buffer memory, or a combination thereof. The hardware can include digital circuitry with dedicated (e.g., hard-coded) logic to perform the operations described herein. The memory sub-system controller 115 can be a microcontroller, special purpose logic circuitry (e.g., a field programmable gate array (FPGA), an application specific integrated circuit (ASIC), and so forth), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some examples, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, GC operations, error detection and ECC operations, encryption operations, caching operations, and address translations between a logical address (e.g., LBA, namespace) and a physical memory address (e.g., physical block address in a physical address space of the memory device 130 or memory device 140) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some examples, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some examples, a memory device 130 is a managed memory device, which is a raw memory device combined with a local controller (e.g., local media controller 135) for media management within the same memory device package. An example of a managed memory device is a managed NAND (MNAND) device. Any operation discussed as being performed by the memory sub-system controller 115 can be similarly performed by the local media controllers 135 and vice versa. Any discussion with respect to the memory device 130 can similarly be applied to the memory device 140.

The memory sub-system controller 115 includes an L2P table deallocation component 113. The L2P table deallocation component 113 can manage deallocation of regions of the L2P table based on instructions received from the host system 120 or other system components. In some examples, the L2P table deallocation component 113 dynamically adjusts the priority deallocate size (e.g., the deallocation of portions of an L2P region that remain non-deallocated when a front (head) set of LTUs and a tail set of LTUs of the region are deallocated in response to a deallocate command from the host system 120) of a region of the L2P table. The L2P table deallocation component 113 performs this dynamic adjustment, according to the host write block size, using "size-info bits" to represent the initial write block size. This enables the L2P table deallocation component 113 (through a deallocation component) to determine the optimal priority deallocate sub-region size, which reduces unnecessary deallocation efforts. The L2P table deallocation component 113 optimizes the background deallocation process by combining contiguous sub-regions for deallocation in one operation, which reduces the overhead associated with pre-process and post-process operations. This adaptive approach allows the L2P table deallocation component 113 to balance deallocation operations with ongoing read and write tasks more effectively.

By dynamically selecting the number of sub-regions to deallocate based on the size of incoming write commands, the L2P table deallocation component 113 can improve write performance, such as for random write patterns. This workload-aware functionality integrated within the memory sub-system 110 enhances the efficiency and flexibility of the storage device, reducing write latency across various workload scenarios. Ultimately, the L2P table deallocation component 113 provides a customizable balance between deallocation granularity and write performance, addressing the limitations of conventional fixed deallocation strategies and adapting to diverse I/O patterns and performance requirements.

In some examples, the L2P table deallocation component 113 receives a request to deallocate entries in a L2P table. These entries correspond to a memory device region of the memory device 140 containing multiple LTUs. Upon receiving this request, the L2P table deallocation component 113 first deallocates the front and tail sets of LTUs in the region, leaving a non-deallocated portion in the middle. The L2P table deallocation component 113 then divides this non-deallocated portion into several sub-regions. When a write command is received from a host system 120, the L2P table deallocation component 113 computes the size of this command. Based on this size, the L2P table deallocation component 113 dynamically selects a number of sub-regions from the non-deallocated portion to deallocate.

In some cases, after deallocating the front and tail sets, the L2P table deallocation component 113 communicates to the host system 120 that the deallocation request has been completed. This allows the host system 120 to proceed with other operations while the remaining deallocation occurs in the background. To keep track of the deallocation status, the L2P table deallocation component 113 can store information for each entry in the L2P table corresponding to the non-deallocated portion. When a write command targets an LTU in the non-deallocated portion, the L2P table deallocation component 113 can determine this and select the appropriate number of sub-regions to deallocate based on the write command's size. The size of the selected sub-regions is designed to be larger than the write command size but smaller than the entire non-deallocated portion.

In some examples, the sub-regions can be configured in different ways. The sub-regions may all correspond to the same number of LTUs, or they might be divided into portions with different LTU counts. The L2P table deallocation component 113 can access configuration information (e.g., stored in the local memory 119) to determine the region size and the number of LTUs each sub-region should represent. The L2P table deallocation component 113 can then generate the sub-regions based on this information. If the region size is equally divisible by the sub-region LTU count, all sub-regions may be configured to have the same number of LTUs. If not, some sub-regions may have fewer LTUs than others.

When selecting sub-regions to deallocate, the L2P table deallocation component 113 can compare the write command size to the sub-region size. If the command size is smaller than the sub-region size stored in the configuration information, the L2P table deallocation component 113 can select at least one sub-region. If the command size larger than the sub-region size stored in the configuration information, the L2P table deallocation component 113 can select multiple sub-regions to match or exceed the write command size. The number of sub-regions to deallocate can be determined by dividing the write command size by the number of LTUs per sub-region, stored in the configuration information. To improve background deallocation, the L2P table deallocation component 113 identifies contiguous portions of sub-regions between already deallocated sub-regions and deallocates them completely in one process. This approach is particularly efficient when different write commands have caused non-contiguous deallocation patterns. When deallocating an individual sub-region, the L2P table deallocation component 113 can invalidate the corresponding L2P entries, identify the associated physical blocks, decreases the valid translation unit count for each block, and update a bitmap to mark the sub-region as deallocated.

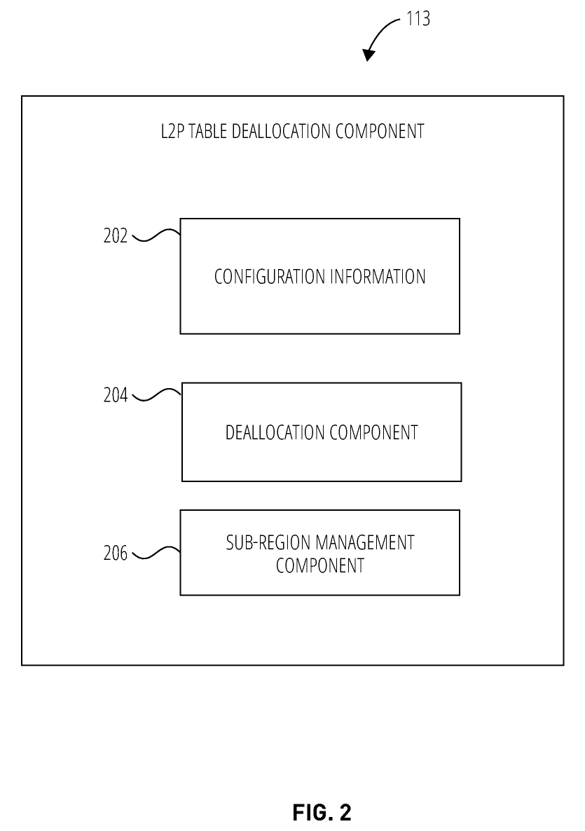

FIG. 2 is a block diagram of an L2P table deallocation component 113, in accordance with some examples. The L2P table deallocation component 113 can include a configuration information 202, a sub-region management component 206, and/or a deallocation component 204. Specifically, the L2P table deallocation component 113 includes several subcomponents that work together to implement the novel workload adaptive deallocation method/process.

In some examples, the configuration information 202 (which can be part of the local memory 119) stores data about the structure of the memory sub-system 110, including the region size, the number of LTUs per sub-region, and other parameters needed for the adaptive deallocation process. The deallocation component 204 is the element responsible for executing the actual deallocation operations. The deallocation component 204 handles both the foreground and background deallocation processes (mentioned above), including the priority deallocation when a write command conflicts with ongoing background deallocation. The sub-region management component 206 is responsible for dividing the non-deallocated portion of a region into sub-regions and managing these sub-regions throughout the deallocation process.

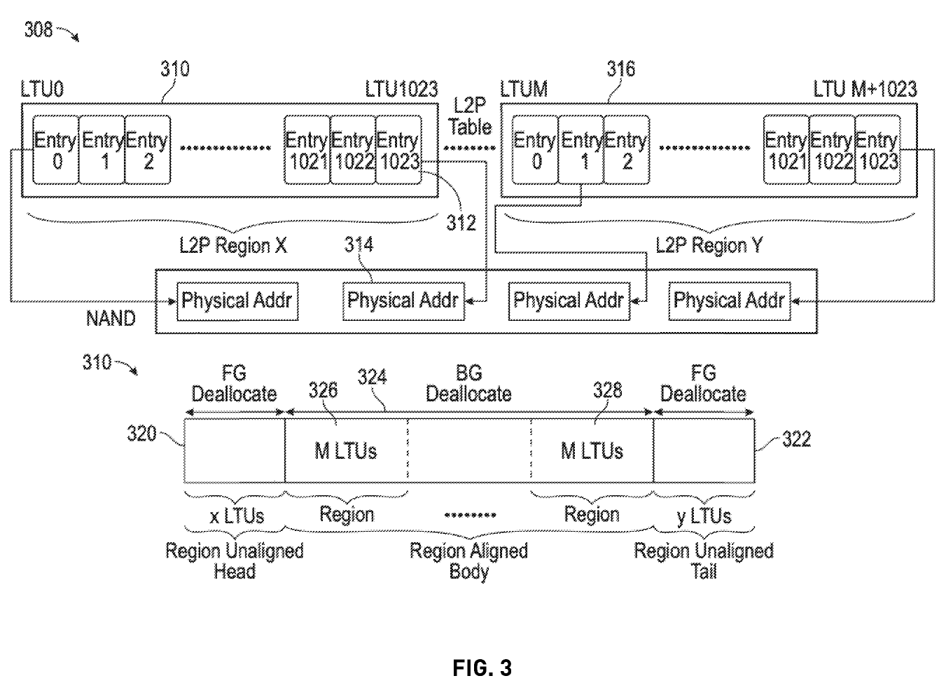

When a deallocation request is received, the L2P table deallocation component 113 (e.g., the deallocation component 204) first deallocates the front and tail sets of LTUs in the specified region. Referring to FIG. 3, this process is illustrated in the diagram 308. For example, as shown in the diagram 308, FIG. 3 illustrates the process of L2P table deallocation, showing how the front (head) set of LTUs and tail set of LTUs are created, leaving the non-deallocated portion of the region 324.

Two L2P table regions first L2P table region 310 and second L2P table region 316 are shown in the diagram 308. Each region (first L2P table region 310 and second L2P table region 316) can include multiple L2P table entries 312, which map logical addresses to physical addresses 314 in the NAND memory (e.g., memory device 130). When a deallocation request is received, the deallocation component 204 first deallocates the front set of LTUs 320 (region unaligned head) and the tail set of LTUs 322 (region unaligned tail). This process involves invalidating the corresponding L2P entries, identifying the associated physical blocks, decreasing the valid translation unit count (VTC) for each affected block, and updating a bitmap (a table that associates each L2P entry with deallocation status information indicating whether the corresponding entry has been deallocated or is non-deallocated and/or is valid) to indicate that these portions have been deallocated.

After deallocating the front and tail sets (front set of LTUs 320 and tail set of LTUs 322), the first L2P table region 310 (or second L2P table region 316 depending on which LTUs are being deallocated by the request) is left with the non-deallocated portion of the region 324 (region aligned body). This non-deallocated portion of the region 324 can be divided by the sub-region management component 206 into sub-regions, such as first sub-region 326 and second sub-region 328 (and many other regions between the first sub-region 326 and second sub-region 328), for more efficient background deallocation.

The non-deallocated portion of the region 324 can be deallocated in the background (BG) while the host system 120 performs other tasks and when the memory device 130 has downtime. This background deallocation process allows the L2P table deallocation component 113 to acknowledge command completion to the host system 120 quickly, improving responsiveness. However, if a host write command is received from the host system 120 by the L2P table deallocation component 113 and is determined to overlap with one of the LTUs in the non-deallocated portion of the region 324 (which have yet to be deallocated), the deallocation component 204 prioritizes background deallocation for at least that specific area. This prioritization ensures that the write operation can proceed without conflicts. The sub-region management component 206 dynamically selects the number of sub-regions (e.g., from the non-deallocated portion of the region 324 including the first sub-region 326 and the second sub-region 328) to deallocate based on the size of the incoming write command, optimizing the balance between deallocation operations and write performance. This adaptive approach allows the system to efficiently handle various write sizes and patterns, from small 4KB writes to larger 512KB or beyond writes, while maintaining optimal performance and responsiveness.

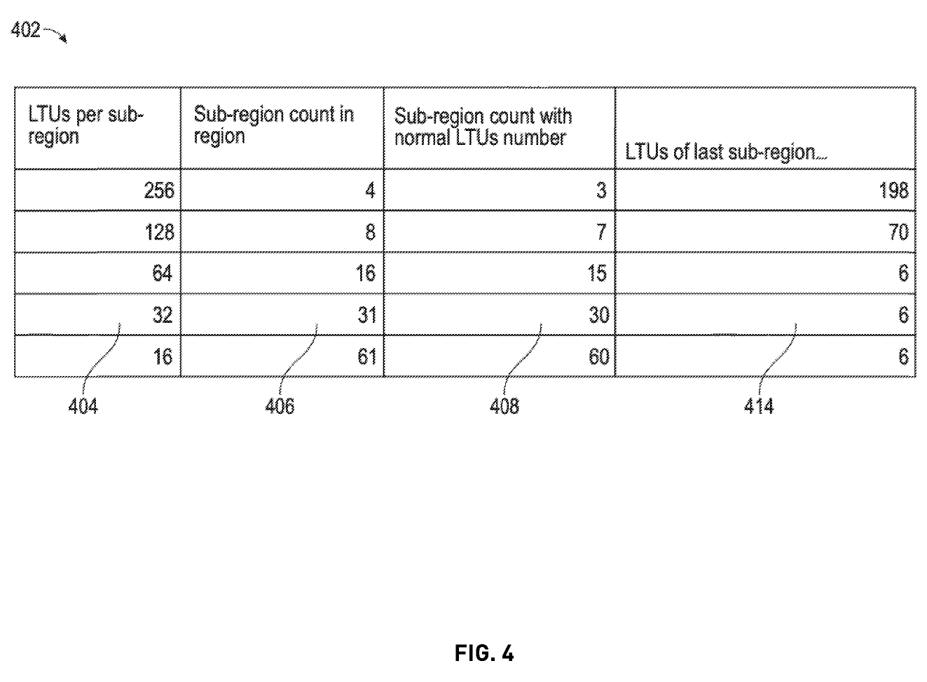

Referring back to FIG. 2, the deallocation component 204 can dynamically divide the non-deallocated portion of the region 324 into sub-regions (e.g., first sub-region 326 through second sub-region 328) based on the configuration information 202. For example, FIG. 4 illustrates L2P table configuration 402 based on the configuration information 202 for L2P sub-regions, which is used for determining the number and size of sub-regions within a given L2P table region (e.g., within the non-deallocated portion of the region 324). In some cases, the configuration information 202 of the L2P table deallocation component 113 can specify parameters, such as the region size and the number of LTUs per sub-region.

The L2P table configuration 402 shows a table with several rows, each representing different possible configurations for sub-regions. For example, a first column, "LTUs per sub-region," indicates the number of LTUs per sub-region 404 that each sub-region can contain. The second column, "sub-region count in region," shows the total number of sub-regions 406 that would be created for a given configuration. For example, one row might show a configuration where each sub-region contains 256 LTUs, resulting in 4 sub-regions per region. Another row might show a configuration with 32 LTUs per sub-region, resulting in 32 sub-regions per region. These configurations may allow for equal-sized sub-regions when the region size is evenly divisible by the sub-region size.

However, FIG. 4 also accounts for cases where the region size is not evenly divisible by the sub-region size. In such cases, additional columns come into play: "sub-region count with normal LTUs number" and "LTUs of last sub-region" (e.g., number of identical size sub-regions 408 and number of LTUs in remaining sub-region 414). These columns allow for the creation of non-equal sized sub-regions. For instance, in a configuration where the region size is 966 LTUs and the sub-region size is set to 32 LTUs, 30 full-sized sub-regions (number of identical size sub-regions 408) of 32 LTUs each can be generated with an additional smaller sub-region of 6 LTUs (number of LTUs in remaining sub-region 414). Namely, in such a configuration, there may be 30 sub-regions with equal or the same quantity or number of LTUs and one sub-region that covers a remaining portion of the LTUs.

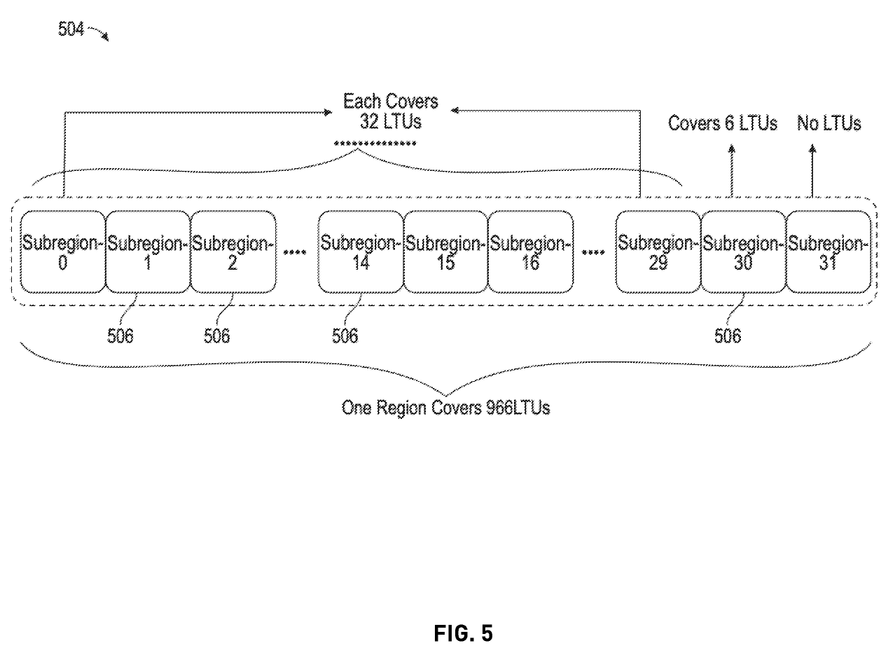

FIG. 5 illustrates the practical implementation of the sub-region division concept discussed in FIG. 4, particularly for cases where the region size is not evenly divisible by the sub-region size. The diagram 504 in FIG. 5 visually represents a single region covering 966 LTUs. This region is divided into multiple sub-regions, with the majority being identical size sub-regions 506. In this specific example, the sub-region management component 206 generates the identical size sub-regions 506 each covering 32 LTUs. These sub-regions represent the "sub-region count with normal LTUs number" from FIG. 4, which in this case would be 30 full-sized sub-regions. At the end of the region, the sub-region management component 206 generates the remaining sub-region 508, which covers 6 LTUs. This smaller remaining sub-region 508 corresponds to the "LTUs of last sub-region" column in FIG. 4, representing the portion that could not be evenly divided into the standard 32-LTU sub-regions. The visual representation in FIG. 5 demonstrates how the sub-region management component 206 handles cases where the region size (966 LTUs) is not evenly divisible by the chosen sub-region size (32 LTUs). It shows that the sub-region management component 206 creates as many full-sized sub-regions as possible (30 in this case), and then allocates the remaining LTUs (6 in this example) to a smaller, final sub-region.

This approach allows for efficient use of the entire region while maintaining a consistent sub-region size for the majority of the LTUs. It provides a balance between uniformity for most of the region and flexibility to accommodate the remaining LTUs, which is important for optimizing deallocation operations and improving overall write performance in various workload scenarios.

As another example, in a configuration where the region size is 966 LTUs and the sub-region size is set to 128 LTUs, 7 full-sized sub-regions (number of identical size sub-regions 408) of 128 LTUs each can be generated with an additional smaller sub-region of 70 LTUs (number of LTUs in remaining sub-region 414). In this configuration, there would be 7 sub-regions with equal or the same quantity or number of LTUs and one sub-region that covers the remaining portion of the LTUs. Another example could be a configuration where the region size is 966 LTUs and the sub-region size is set to 16 LTUs. In this case, 60 full-sized sub-regions (number of identical size sub-regions 408) of 16 LTUs each can be generated with an additional smaller sub-region of 6 LTUs (number of LTUs in remaining sub-region 414). This configuration would result in 60 sub-regions with equal or the same quantity or number of LTUs and one sub-region that covers the remaining portion of the LTUs.

As another example, in a configuration where the region size is 1024 LTUs and the sub-region size is set to 128 LTUs, 8 full-sized sub-regions (number of identical size sub-regions 408) of 128 LTUs each can be generated without any remaining LTUs. In this configuration, there would be 8 sub-regions with equal or the same quantity or number of LTUs, and no additional sub-region would be needed to cover any remaining portion of the LTUs. Another example could be a configuration where the region size is 1024 LTUs and the sub-region size is set to 16 LTUs. In this case, 64 full-sized sub-regions (number of identical size sub-regions 408) of 16 LTUs each can be generated without any remaining LTUs. This configuration would result in 64 sub-regions with equal or the same quantity or number of LTUs, and again, no additional sub-region would be needed to cover any remaining portion of the LTUs. In both of these examples with a 1024 LTU implementation, the region size is evenly divisible by the sub-region size, resulting in equal-sized sub-regions without any remainder.

This flexible configuration allows the system to adapt to various memory device structures and improve the balance between deallocation granularity and performance. By adjusting these parameters, the sub-region management component 206 can create an appropriate number of sub-regions for efficient workload-adaptive deallocation, improving write performance across different scenarios and workload patterns. Upon receiving a write command from the host, the deallocation component 204 computes the size of the command and dynamically selects the number of sub-regions to deallocate based on this size. This adaptive approach allows for efficient handling of various write sizes, from small 4KB writes to larger 512KB, or beyond, writes.

Specifically, the deallocation component 204 can receive a request/command from the host system 120 to write new data to the non-deallocated portion of the region 324. In such cases, the deallocation component 204 (or the controller 115 at a front end) determines a size of the write command and selects how many sub-regions within the non-deallocated portion of the region 324 to deallocate to satisfy the command. The deallocation component 204 performs this operation in cases where the LTUs of the write command overlap at least one LTU of the non-deallocated portion of the region 324.

In some cases, the process of determining the host command size and using it to decide how many sub-regions to deallocate involves several steps. When a write command is received from the host system 120, the L2P table deallocation component 113 (or another front-end component, such as memory sub-system controller 115) computes its size. This size information is encoded into "size-info bits" by the front-end firmware or memory sub-system controller 115. These bits represent the initial write block size and are passed along with the write command to the L2P table deallocation component 113 which can form part of the FTL (Flash Translation Layer) domain.

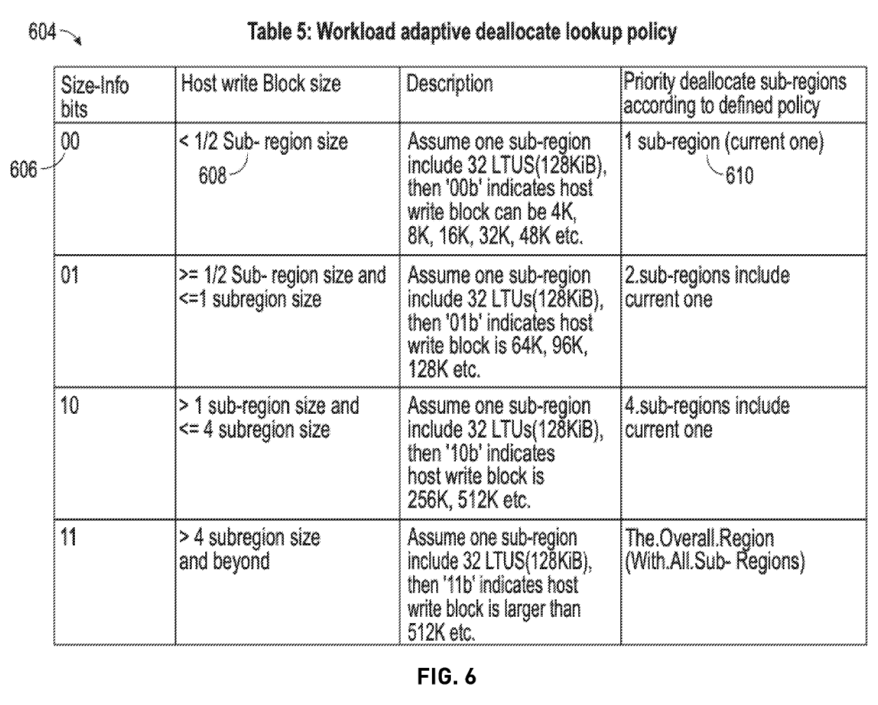

The size-info bits can use two bits to represent four different categories of write sizes. For example, '00' can represent write sizes smaller than half a sub-region (e.g., 4K, 8K, 16K, 32K), '01' can represents write size between half and one full sub-region, '10' can represent write sizes larger than one sub-region but less than or equal to four sub-regions, and '11' can represent write sizes larger than four sub-regions. The deallocation component 204 receives these size-info bits along with the write command. The deallocation component 204 then uses this information, in conjunction with the sub-region size specified in the configuration information, to determine how many sub-regions need to be deallocated. For example, the deallocation component 204 can access or store a deallocation policy lookup 604 (shown in FIG. 6) in a local memory 119. The deallocation component 204 searches the host size information 606 based on the size-info bits to identify the host write block size 608 and the corresponding number of sub-regions 610 that are needed from the deallocation policy lookup 604.

The number of sub-regions to deallocate can be calculated by the sub-region management component 206 using the formula: N = ROUNDUP (host write LTU count / sub-region LTU count). For example, if the host write size is 128K and each sub-region contains 32 LTUs (128K), the sub-region management component 206 can calculate N = ROUNDUP (32 / 32) = 1, meaning one sub-region would need to be deallocated. As another example, the host write size can be computed to be 384K and each sub-region can contain 128 LTUs (512K). The sub-region management component 206 can calculate N = ROUNDUP (96 / 128) = ROUNDUP (0.75) = 1. However, in this case, the sub-region management component 206 may actually need to deallocate three sub-regions to fully accommodate the write command. This is because the size-info bits may indicate a larger write size category, specifically '10' which represents write sizes larger than one sub-region but less than or equal to four sub-regions. In this scenario, even though the mathematical calculation suggests only one sub-region, the sub-region management component 206 may determine that the write size spans across multiple sub-regions and adjust accordingly. The deallocation component 204 may then proceed to deallocate the contiguous or non-contiguous sub-regions to ensure that the entire write command can be accommodated without conflicts with existing data.

As another example, if the write command is 256K and each sub-region contains 32 LTUs (128K), the sub-region management component 206 can calculate: N = ROUNDUP (64 / 32) = ROUNDUP (2) = 2. In this case, the sub-region management component 206 may need to deallocate two sub-regions to fully accommodate the write command. This aligns with the size-info bits indicating a write size category of '10', which represents write sizes larger than one sub-region but less than or equal to four sub-regions. The deallocation component 204 may then proceed to deallocate two contiguous or non-contiguous sub-regions, depending on the current state of the L2P table and the specific LTUs targeted by the write command. This ensures that the entire 256K write command can be accommodated without conflicts with existing data.

As another example, for the '00' configuration, a write command of 32K may fall into this category. In this case, N = ROUNDUP (8 / 32) = 1. The deallocation component 204 may deallocate one sub-region, even though the write size is smaller than half a sub-region. This ensures that at least one full sub-region is always deallocated to accommodate the write command. For the '11' configuration, a write command of 640K may fall into this category. In this case, N = ROUNDUP (160 / 32) = 5. However, because the '11' configuration indicates a write size larger than four sub-regions, the deallocation component 204 may deallocate the entire region, which may consist of 32 sub-regions (assuming a region size of 1024 LTUs).

Once the deallocation component 204 has determined the number of sub-regions to deallocate, the deallocation component 204 performs several steps. First, the deallocation component 204 selects the appropriate sub-regions for deallocation based on the write command's target LTUs. For each selected sub-region, the deallocation component 204 invalidates the corresponding L2P entries, identifies the associated physical blocks, and decreases the valid translation unit count (VTC) for each identified block. The deallocation component 204 then updates a sub-region bitmap to indicate that these sub-regions have been deallocated. This bitmap is used to keep track of the deallocation status of each sub-region within the larger region. After the deallocation process is complete for the required sub-regions, the deallocation component 204 allows the write command to proceed, updating the L2P entries for the newly written data.

This adaptive approach allows the system to balance deallocation operations with write performance, deallocating only as much as necessary based on the size of each incoming write command. This results in improved write performance, especially for random write patterns, as it minimizes unnecessary deallocation overhead.

Referring back to FIG. 2, the sub-region management component 206 can implement an optimized background deallocation process. The sub-region management component 206 can identify contiguous portions of non-deallocated sub-regions and deallocates them in a single operation, reducing the overhead associated with multiple separate deallocation operations. For individual sub-region deallocation, the sub-region management component 206 performs several steps: invalidating the corresponding L2P entries, identifying the associated physical blocks, decreasing the valid translation unit count for each block, and updating a bitmap to mark the sub-region as deallocated.

The L2P table deallocation component 113 can adapt to different region sizes and sub-region configurations. The L2P table deallocation component 113 can handle cases where the region size is equally divisible by the sub-region size, creating uniform sub-regions, as well as cases where the division is unequal, resulting in some sub-regions with fewer LTUs. This adaptive approach allows the system to balance deallocation operations with ongoing read and write tasks more effectively, particularly in datacenter environments where consistent high performance and low latency are important considerations. By dynamically adjusting the deallocation granularity based on the write command size, the L2P table deallocation component 113 can improve write performance, such as for random write patterns.

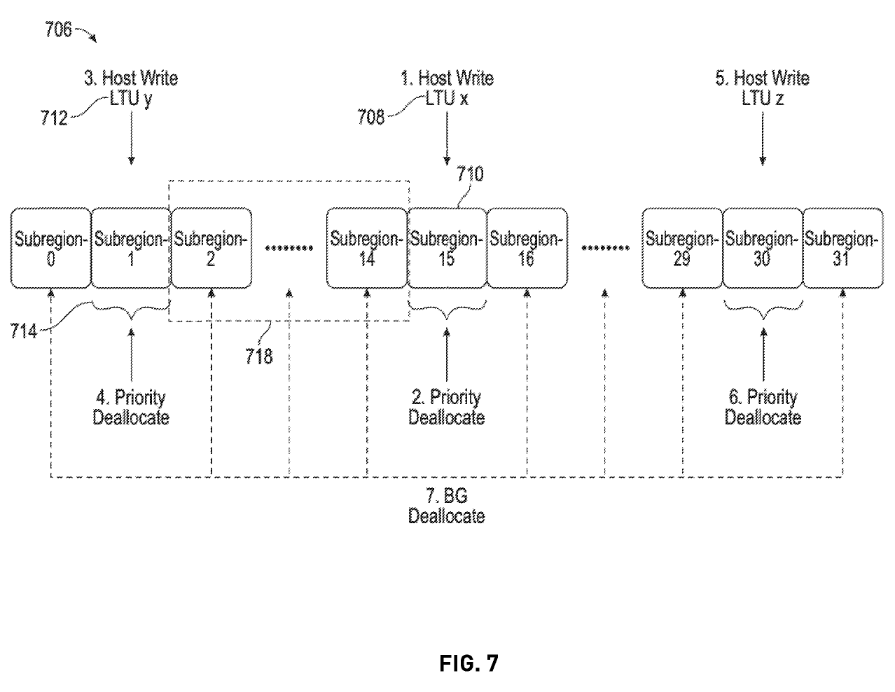

FIG. 7 illustrates a deallocation diagram 706 of an adaptive background deallocation process, in accordance with some examples. Specifically, FIG. 7 illustrates the workload adaptive background (BG) deallocation process, demonstrating how the L2P table deallocation component 113 efficiently deallocates contiguous portions of sub-regions rather than deallocating on a sub-region by sub-region basis.

In the deallocation diagram 706, a region (e.g., non-deallocated portion of the region 324) can be divided into multiple sub-regions. A first host write command 708 can trigger a priority deallocation of the first deallocated sub-region 710. Namely, the L2P table deallocation component 113 can receive the first host write command 708, can determine that an LTU of the first host write command 708 overlaps with at least LTUs of the first deallocated sub-region 710. In such cases, the L2P table deallocation component 113 deallocates enough sub-regions including the first deallocated sub-region 710 to allow the first host write command 708 to be completed. Similarly, the second host write command 712 leads to the priority deallocation of the second deallocated sub-region 714.

After these priority deallocations, the non-deallocated portion of the region 324 can be left with a contiguous non-deallocated portion 718. This contiguous non-deallocated portion 718 can include multiple sub-regions that are contiguous and adjacent to each other that fall between the second deallocated sub-region 714 and the first deallocated sub-region 710. Instead of deallocating each sub-region in this contiguous non-deallocated portion 718 individually, the BG deallocation process performed by the L2P table deallocation component 113 combines these contiguous sub-regions and deallocates them in one operation (e.g., completely deallocates the contiguous non-deallocated portion 718).

This approach reduces the overhead associated with deallocation. Each deallocation operation involves pre-process and post-process steps, such as invalidating L2P entries, identifying associated physical blocks, and decreasing valid translation unit counts (VTCs). By combining contiguous sub-regions, the L2P table deallocation component 113 can perform these steps once for the entire contiguous portion, rather than repeating them for each individual sub-region.

For example, if there were ten contiguous sub-regions in contiguous non-deallocated portion 718, a sub-region by sub-region approach would require ten separate deallocation operations. However, with this optimized BG deallocation process, all ten sub-regions of the contiguous non-deallocated portion 718 can be deallocated in a single operation, significantly reducing the time and computational resources required. This method is particularly efficient when different write commands have caused non-contiguous deallocation patterns, as shown by the separated deallocated sub-region's first deallocated sub-region 710 and second deallocated sub-region 714. The BG deallocation process can then efficiently clean up the remaining contiguous portions, optimizing the overall deallocation process and improving the memory sub-system 110 write performance.

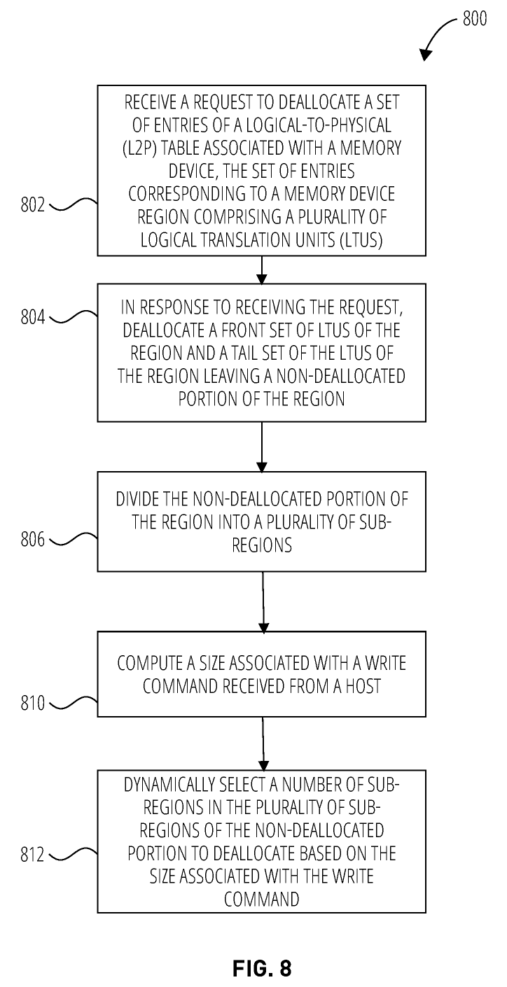

FIG. 8 is a flow diagram of an example routine 800 (method or process) performed using the L2P table deallocation component 113, in accordance with some examples. The method or process of routine 800 can be performed by processing logic that can include hardware (e.g., a processing device, circuitry, dedicated logic, programmable logic, microcode, hardware of a device, an integrated circuit, and so forth), software (e.g., instructions run or executed on a processing device), or a combination thereof. In some examples, the method or process of routine 800 is performed by the memory sub-system controller 115 or subcomponents of the memory sub-system controller 115 of FIG. 1. In these examples, the method or process of routine 800 can be performed, at least in part, by the L2P table deallocation component 113. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring now to FIG. 8, the method or process of routine 800 begin at operation 802, with the L2P table deallocation component 113 of a memory sub-system 110 (e.g., memory device 140) receiving a request to deallocate a set of entries of a L2P table associated with a memory device, the set of entries corresponding to a memory device region comprising a plurality of LTUs. Then, at operation 804, the L2P table deallocation component 113 in response to receiving the request, deallocates a front set of LTUs of the region and a tail set of the LTUs of the region leaving a non-deallocated portion of the region. At operation 806, the L2P table deallocation component 113 divides the non-deallocated portion of the region into a plurality of sub-regions. The L2P table deallocation component 113, at operation 810, computes a size associated with a write command received from a host and, at operation 812, dynamically selects a number of sub-regions in the plurality of sub-regions of the non-deallocated portion to deallocate based on the size associated with the write command.

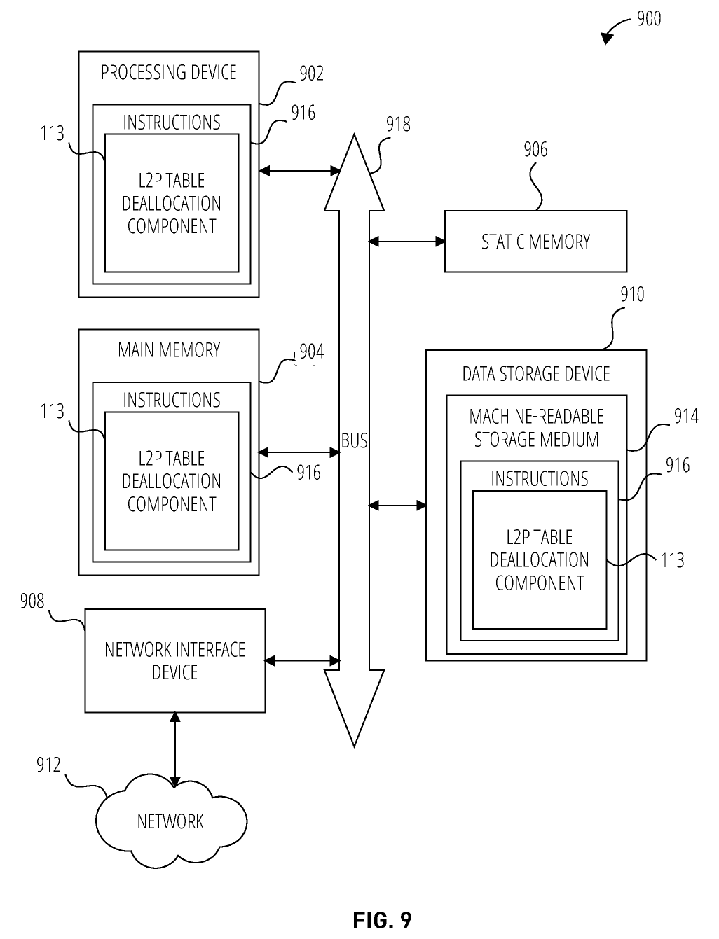

FIG. 9 illustrates an example machine in the form of a computer system 900 within which a set of instructions can be executed for causing the machine to perform any one or more of the methodologies discussed herein. In some examples, the computer system 900 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., ROM, flash memory, DRAM such as SDRAM or Rambus DRAM (RDRAM), etc.), a static memory 906 (e.g., flash memory, static random access memory (SRAM), etc.), and a data storage device 910, which communicate with each other via a bus 918.

The processing device 902 represents one or more general-purpose processing devices such as a microprocessor, a central processing unit, or the like. More particularly, the processing device 902 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 902 can also be one or more special-purpose processing devices such as an application-specific integrated circuit (ASIC), a field programmable gate array (FPGA), a digital signal processor (DSP), a network processor, or the like. The processing device 902 is configured to execute instructions 916 for performing the operations and steps discussed herein. The computer system 900 can further include a network interface device 908 to communicate over a network 912.

The data storage device 910 can include a machine-readable storage medium 914 (also known as a computer-readable medium) on which is stored one or more sets of instructions 916 or software embodying any one or more of the methodologies or functions described herein. The instructions 916 can also reside, completely or at least partially, within the main memory 904 and/or within the processing device 902 during execution thereof by the computer system 900, the main memory 904 and the processing device 902 also constituting machine-readable storage media. The machine-readable storage medium 914, data storage device 910, and/or main memory 904 can correspond to the memory sub-system 110 of FIG. 1.

In one example, the instructions 916 include instructions to implement functionality corresponding to providing block failure protection for a zone memory sub-system as described herein (e.g., the L2P table deallocation component 113 of FIG. 1). While the machine-readable storage medium 914 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1. A system comprising: a memory device; and a processing device, operatively coupled to the memory device, configured to perform operations comprising: receiving a request to deallocate a set of entries of a logical-to-physical (L2P) table associated with the memory device, the set of entries corresponding to a memory device region comprising a plurality of logical translation units (LTUs); in response to receiving the request, deallocating a front set of LTUs of the region and a tail set of the LTUs of the region leaving a non-deallocated portion of the region; dividing the non-deallocated portion of the region into a plurality of sub-regions; computing a size associated with a write command received from a host; and dynamically selecting a number of sub-regions in the plurality of sub-regions of the non-deallocated portion to deallocate based on the size associated with the write command.

Example 2. The system of Example 1, wherein the request to deallocate the set of entries is received from the host, the operations comprising: communicating a completion of the request to deallocate the set of entries to the host in response to deallocating the front set of LTUs of the region and the tail set of the LTUs of the region leaving the non-deallocated portion of the region.

Example 3. The system of any one of Examples 1-2, the operations comprising: storing deallocation status information for each entry in the set of entries in the L2P table corresponding to the non-deallocated portion.

Example 4. The system of any one of Examples 1-3, the operations comprising: determining whether the write command corresponds to writing data to an individual LTU that is in the non-deallocated portion of the region; and in response to determining that the write command corresponds to writing data to the individual LTU that is in the non-deallocated portion of the region, dynamically selecting the number of sub-regions in the plurality of sub-regions of the non-deallocated portion to deallocate based on the size associated with the write command.

Example 5. The system of any one of Examples 1-4, wherein a size corresponding to the selected number of sub-regions is greater than the size associated with a write command received from a host and less than a size of the non-deallocated portion of the region.

Example 6. The system of Example 5, wherein each sub-region in the plurality of sub-regions corresponds to a same number of LTUs.

Example 7. The system of any one of Examples 5-6, wherein a first portion of sub-regions in the plurality of sub-regions corresponds to a first number of LTUs and a second portion of sub-regions in the plurality of sub-regions corresponds to a second number of LTUs.

Example 8. The system of any one of Examples 5-7, the operations comprising: accessing configuration information associated with the memory device to determine a region size of the non-deallocated portion comprising a specified number of LTUs; obtaining, based on the configuration information, a number of LTUs for each sub-region of the plurality of sub-regions to represent; and generating the plurality of sub-regions as a function of the region size and the obtained number of LTUs.

Example 9. The system of Example 8, the operations comprising: determining that the region size is equally divisible by the obtained number of LTUs; and in response to determining that the region size is equally divisible by the obtained number of LTUs, forming the plurality of sub-regions each representing a same number of LTUs.

Example 10. The system of any one of Examples 8-9, the operations comprising: determining that the region size is unequally divisible by the obtained number of LTUs; and in response to determining that the region size is unequally divisible by the obtained number of LTUs, forming the plurality of sub-regions having a first portion of sub-regions representing the obtained number of LTUs and having a second portion of sub-regions representing less than the obtained number of LTUs.

Example 11. The system of any one of Examples 8-10, the operations comprising: determining that the size associated with the write command received from the host is less than the obtained number of LTUs each sub-region represents; and in response to determining that the size associated with the write command received from the host is less than the obtained number of LTUs each sub-region represents, selecting at least one sub-region from the plurality of sub-regions.

Example 12. The system of any one of Examples 8-11, the operations comprising: determining that the size associated with the write command received from the host is greater than the obtained number of LTUs each sub-region represents; and in response to determining that the size associated with the write command received from the host is greater than the obtained number of LTUs each sub-region represents, selecting multiple sub-regions from the plurality of sub-regions corresponding to a total number of LTUs matching the size associated with the write command.

Example 13. The system of any one of Examples 8-12, the operations comprising: dividing the size associated with the write command by the obtained number of LTUs; and determining the number of sub-regions to selected for deallocation in response to dividing the size associated with the write command by the obtained number of LTUs.

Example 14. The system of any one of Examples 1-13, the operations comprising: identifying a contiguous portion of sub-regions of the plurality of sub-regions, the contiguous portion of sub-regions being between a first sub-region that has been deallocated and a second sub-region that has been deallocated; and performing a background deallocation process to completely deallocate the contiguous portion.

Example 15. The system of Example 14, wherein the first sub-region has been deallocated in response to a first write command from the host and the second sub-region has been deallocated in response to a second write command from the host.

Example 16. The system of any one of Examples 1-15, the operations comprising: selecting an individual sub-region of the plurality of sub-regions to de-allocate; invalidating L2P entries corresponding to LTUs within the individual sub-region; identifying physical blocks associated with the invalidated L2P entries; decreasing a valid translation unit (TU) count (VTC) of each identified physical block; and updating a sub-region bitmap to indicate that the individual sub-region has been deallocated.

Example 17. The system of any one of Examples 1-16, wherein the memory device and the processing device are implemented as part of a single solid state drive (SSD).

Example 18. The system of Example 17, wherein the memory device comprises a three-dimensional (3D) NAND device.

Example 19. At least one non-transitory machine-readable storage medium comprising instructions that, when executed by a processing device, cause the processing device to perform operations comprising: receiving a request to deallocate a set of entries of a logical-to-physical (L2P) table associated with a memory device, the set of entries corresponding to a memory device region comprising a plurality of logical translation units (LTUs); in response to receiving the request, deallocating a front set of LTUs of the region and a tail set of the LTUs of the region leaving a non-deallocated portion of the region; dividing the non-deallocated portion of the region into a plurality of sub-regions; computing a size associated with a write command received from a host; and dynamically selecting a number of sub-regions in the plurality of sub-regions of the non-deallocated portion to deallocate based on the size associated with the write command.

Example 20. A method comprising: receiving a request to deallocate a set of entries of a logical-to-physical (L2P) table associated with a memory device, the set of entries corresponding to a memory device region comprising a plurality of logical translation units (LTUs); in response to receiving the request, deallocating a front set of LTUs of the region and a tail set of the LTUs of the region leaving a non-deallocated portion of the region; dividing the non-deallocated portion of the region into a plurality of sub-regions; computing a size associated with a write command received from a host; and dynamically selecting a number of sub-regions in the plurality of sub-regions of the non-deallocated portion to deallocate based on the size associated with the write command.

The term “coupled with” generally refers to a connection between components, which can be an indirect communicative connection or direct communicative connection (e.g., without intervening components), whether wired or wireless, including connections such as electrical, optical, magnetic, and the like.

“System data” hereinafter refers to data that is created and/or maintained by the memory sub-system for performing operations in response to host requests and for media management.

“User data” hereinafter generally refers to host data and garbage collection data.

“Folding” refers to an operation where data from multiple partially filled pages or blocks is combined and rewritten into a single page or block. This process helps to optimize storage space utilization, reduce write amplification, and improve overall performance of the NAND storage device by consolidating fragmented data and freeing up space for new writes. Folding and “relocation” operations are used interchangeably and mean the same thing.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, examples of the disclosure have been described with reference to specific examples thereof. It will be evident that various modifications can be made thereto without departing from the broader scope of examples of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, configured to perform operations comprising:
receiving a request to deallocate a set of entries of a logical-to-physical (L2P) table associated with the memory device, the set of entries corresponding to a memory device region comprising a plurality of logical translation units (LTUs);
in response to receiving the request, deallocating a front set of LTUs of the region and a tail set of the LTUs of the region leaving a non-deallocated portion of the region;
dividing the non-deallocated portion of the region into a plurality of sub-regions;
computing a size associated with a write command received from a host; and
dynamically selecting a number of sub-regions in the plurality of sub-regions of the non-deallocated portion to deallocate based on the size associated with the write command.

2. The system of claim 1, wherein the request to deallocate the set of entries is received from the host, the operations comprising:
communicating a completion of the request to deallocate the set of entries to the host in response to deallocating the front set of LTUs of the region and the tail set of the LTUs of the region leaving the non-deallocated portion of the region.

3. The system of claim 1, the operations comprising:
storing deallocation status information for each entry in the set of entries in the L2P table corresponding to the non-deallocated portion.

4. The system of claim 1, the operations comprising:
determining whether the write command corresponds to writing data to an individual LTU that is in the non-deallocated portion of the region; and
in response to determining that the write command corresponds to writing data to the individual LTU that is in the non-deallocated portion of the region, dynamically selecting the number of sub-regions in the plurality of sub-regions of the non-deallocated portion to deallocate based on the size associated with the write command.

5. The system of claim 1, wherein a size corresponding to the selected number of sub-regions is greater than the size associated with a write command received from a host and less than a size of the non-deallocated portion of the region.

6. The system of claim 5, wherein each sub-region in the plurality of sub-regions corresponds to a same number of LTUs.

7. The system of claim 5, wherein a first portion of sub-regions in the plurality of sub-regions corresponds to a first number of LTUs and a second portion of sub-regions in the plurality of sub-regions corresponds to a second number of LTUs.

8. The system of claim 5, the operations comprising:
accessing configuration information associated with the memory device to determine a region size of the non-deallocated portion comprising a specified number of LTUs;
obtaining, based on the configuration information, a number of LTUs for each sub-region of the plurality of sub-regions to represent; and
generating the plurality of sub-regions as a function of the region size and the obtained number of LTUs.

9. The system of claim 8, the operations comprising:
determining that the region size is equally divisible by the obtained number of LTUs; and
in response to determining that the region size is equally divisible by the obtained number of LTUs, forming the plurality of sub-regions each representing a same number of LTUs.

10. The system of claim 8, the operations comprising:
determining that the region size is unequally divisible by the obtained number of LTUs; and
in response to determining that the region size is unequally divisible by the obtained number of LTUs, forming the plurality of sub-regions having a first portion of sub-regions representing the obtained number of LTUs and having a second portion of sub-regions representing less than the obtained number of LTUs.

11. The system of claim 8, the operations comprising:
determining that the size associated with the write command received from the host is less than the obtained number of LTUs each sub-region represents; and
in response to determining that the size associated with the write command received from the host is less than the obtained number of LTUs each sub-region represents, selecting at least one sub-region from the plurality of sub-regions.

12. The system of claim 8, the operations comprising:
determining that the size associated with the write command received from the host is greater than the obtained number of LTUs each sub-region represents; and
in response to determining that the size associated with the write command received from the host is greater than the obtained number of LTUs each sub-region represents, selecting multiple sub-regions from the plurality of sub-regions corresponding to a total number of LTUs matching the size associated with the write command.

13. The system of claim 8, the operations comprising:
dividing the size associated with the write command by the obtained number of LTUs; and
determining the number of sub-regions to selected for deallocation in response to dividing the size associated with the write command by the obtained number of LTUs.

14. The system of claim 1, the operations comprising:
identifying a contiguous portion of sub-regions of the plurality of sub-regions, the contiguous portion of sub-regions being between a first sub-region that has been deallocated and a second sub-region that has been deallocated; and
performing a background deallocation process to completely deallocate the contiguous portion.

15. The system of claim 14, wherein the first sub-region has been deallocated in response to a first write command from the host and the second sub-region has been deallocated in response to a second write command from the host.

16. The system of claim 1, the operations comprising:
selecting an individual sub-region of the plurality of sub-regions to de-allocate;
invalidating L2P entries corresponding to LTUs within the individual sub-region;
identifying physical blocks associated with the invalidated L2P entries;
decreasing a valid translation unit (TU) count (VTC) of each identified physical block; and
updating a sub-region bitmap to indicate that the individual sub-region has been deallocated.

17. The system of claim 1, wherein the memory device and the processing device are implemented as part of a single solid state drive (SSD).

18. The system of claim 17, wherein the memory device comprises a three-dimensional (3D) NAND device.

19. At least one non-transitory machine-readable storage medium comprising instructions that, when executed by a processing device, cause the processing device to perform operations comprising:
receiving a request to deallocate a set of entries of a logical-to-physical (L2P) table associated with a memory device, the set of entries corresponding to a memory device region comprising a plurality of logical translation units (LTUs);
in response to receiving the request, deallocating a front set of LTUs of the region and a tail set of the LTUs of the region leaving a non-deallocated portion of the region;
dividing the non-deallocated portion of the region into a plurality of sub-regions;
computing a size associated with a write command received from a host; and
dynamically selecting a number of sub-regions in the plurality of sub-regions of the non-deallocated portion to deallocate based on the size associated with the write command.

20. A method comprising:
receiving a request to deallocate a set of entries of a logical-to-physical (L2P) table associated with a memory device, the set of entries corresponding to a memory device region comprising a plurality of logical translation units (LTUs);
in response to receiving the request, deallocating a front set of LTUs of the region and a tail set of the LTUs of the region leaving a non-deallocated portion of the region;
dividing the non-deallocated portion of the region into a plurality of sub-regions;
computing a size associated with a write command received from a host; and
dynamically selecting a number of sub-regions in the plurality of sub-regions of the non-deallocated portion to deallocate based on the size associated with the write command.
